(19) United States
(12) Patent Application Publication
(10) Pub. No.: US 2013/0178402 A1
(43) Pub. Date: Jul. 11, 2013

(54) LUBRICANT COMPOSITION

(71) Applicants: Vanessa Chauveau, Grenoble (FR); Patrick Turello, Craponne (FR); Julien Amadou, Saint Gerard (BE); Olivier Rochez, Namur (BE)

(72) Inventors: Vanessa Chauveau, Grenoble (FR); Patrick Turello, Craponne (FR); Julien Amadou, Saint Gerard (BE); Olivier Rochez, Namur (BE)

(73) Assignees: NANOCYL SA, Sambreville (BE); TOTAL RAFFINAGE MARKETING, Puteaux (FR)

(21) Appl. No.: 13/825,755

(22) PCT Filed: Aug. 25, 2011
(86) PCT No.: PCT/IB11/53733

§ 371 Date: Mar. 22, 2013

(30) Foreign Application Priority Data
Sep. 28, 2010 (FR) 1057834

(51) Int. Cl. C10M 125/02

(52) U.S. Cl. CPC C10M 125/02; B82Y 99/00
USPC 508/131; 508/113; 977/742

(57) ABSTRACT

The disclosure includes a lubricant composition further including: (a) at least one synthetic base oil and optionally at least one additive and (b) carbon nanotubes, the composition having a weight percentage of carbon nanotubes (b) relative to the total amount of base oils (a) of the composition of between 0.15 and 3.50%, the ratio between the weight percentage of carbon nanotubes, and the apparent density of the powder of carbon nanotubes, expressed in g/1 and measured according to the standard ISO 60-ASTM D1895 being greater than 10².

### CROSS-REFERENCE TO RELATED APPLICATIONS

This application is a National Phase Entry of International Application No. PCT/IB2011/053733, filed on Aug. 25, 2011, which claims priority to French Patent Application Serial No. 1057834, filed on Sep. 28, 2010, both of which are incorporated by reference herein.

### BACKGROUND

The present invention relates to lubricant compositions the viscosity behaviour of which is improved by the addition of carbon nanotubes (CNTs). In particular, the carbon nanotubes make it possible to limit the variation in viscosity of these lubricant compositions with temperature.

The viscosity of the lubricant bases generally varies a great deal with temperature. For automobile applications in particular, it is desirable to reduce this dependence on temperature. Thus at high temperature, generally a very significant loss of viscosity occurs, and the lubricant no longer ensures a sufficient film of oil to be effective. In the formulation of lubricants, in particular for automobiles, the use of polymers has made it possible to reduce this dependence on temperature, by increasing the viscosity index (VI) of the lubricants, defined according to the standard ASTM D2270 starting from kinematic viscosities of the lubricants at 40° C. and 100° C. The higher the viscosity index, the lower the variation in viscosity with temperature. The use of these polymers called “viscosity index improvers” (VII or VI improver) allows in particular multigrade oils to be formulated.

In general, polymers are added to very fluid bases. At low temperatures, the polymer chains are folded on themselves and do not contribute to the viscosity of the lubricant. On the other hand at high temperatures, these chains unfold and trap a certain volume of base, and contribute to increasing the viscosity of the lubricant. These polymers are for example olefin copolymers (OCPs), polymethacrylates, hydrogenated styrene butadienes (HSBs) etc. well known in the formulation of lubricants, in particular automobile lubricants, for example for engines.

The use of CNTs for the total or partial replacement of these polymers constitutes a very innovative alternative formulation and has a certain number of advantages. Sometimes at low temperatures the polymers make a non-negligible contribution to the viscosity of the lubricant. Better low-temperature performances can therefore be hoped for, in particular fuel economies in the low temperature phase, with lubricants using CNTs as VI improvers. Moreover, CNTs, in addition to their influence on the rheological behaviour of the lubricants, also provide very useful anti-wear and friction modifier properties.

The principle of the use of nanoparticles for improving the viscosity behaviour of lubricating oils is known. However, few studies exist relating specifically to nanotubes, and the specific conditions under which these nanotubes produce an effect on the variations in viscosity as a function of the temperature of lubricating oils. The application US 2007/0293405 therefore discloses the use of nanoparticles which can be CNTs, at concentrations comprised between 0.001% and 20% as lubricant viscosity modifiers. No specific example relating to CNTs is disclosed, nor any specific characteristic of the CNT powders necessary to obtain an effect on the viscosity variations as a function of temperature.

The publication “Investigation of the Effect of Multiwalled Carbon Nanotubes on the Viscosity Index of Lube Oil Cuts, Chem Eng. Comm. 196:997-1007, 2009” discloses the use of carbon nanotubes, at concentrations comprised between 0.01% and 0.2% by weight, in a lubricating oil. The consistency between the experimental measurements of viscosity and different models for predicting the viscosity of CNT dispersions in a lubricating oil is studied, for concentrations by mass of CNTs comprised between 0.01% and 2%.

Surprisingly, the applicant has noted that the concentration at which the carbon nanotubes must be used in a lubricating oil, in order to minimize the variations in viscosity with the temperature of said lubricating oil, is a function of the apparent density of the carbon nanotube powders used. Contrary to what is shown by the prior art, but without wishing to be bound by any theory, it appears that the organization of the carbon nanotubes (CNTs) in the form of aggregates, allowing the presence of oil entrapped in said aggregates, causes the viscosity-stabilizing effect.

The present invention relates to lubricant compositions where the concentration by mass of carbon nanotubes is a function of their apparent power density, measured according to the standard ISO60-ASTM D1895. The present invention also relates to a method for the preparation of said lubricant compositions, and to their use as engine oil, preferentially for the engines of motor vehicles.

### SUMMARY

The present invention relates to lubricant compositions comprising:
(a) at least one mineral, synthetic or natural base oil and optionally at least one additive
(b) carbon nanotubes,
   the composition having a percentage by mass of carbon nanotubes (b) with respect to the total quantity of base oils (a) of the composition comprised between 0.15 and 3.50%, wherein

the ratio between the percentage by mass of carbon nanotubes and the apparent density of the carbon nanotube powder, measured according to the standard ISO60-ASTM D1895, is greater than 10⁻².

According to a preferred embodiment, the lubricant compositions according to the invention include the ratio between the percentage by mass of carbon nanotubes (b) with respect to the total quantity of base oils (a) of the composition and the apparent density of the carbon nanotube powder, measured according to the standard ISO60-ASTM D1895, is greater than 1.5.10⁻². More preferentially, the lubricant compositions according to the invention include the percentage by mass of carbon nanotubes (b) with respect to the total quantity of base oils (a) of the composition is comprised between 0.2 and 3%, preferentially between 0.3 and 2%, preferentially between 0.4 and 1.5%. According to a preferred embodiment, the lubricant compositions according to the invention include the apparent density of the carbon nanotube powder, measured according to the standard ISO60-ASTM D1895, is comprised between 25 and 200 g/l, preferentially between 40 and 60 g/l. According to a particularly preferred embodiment, the lubricant compositions according to the invention include at least one base oil (a) is a synthetic oil, preferentially a polyalphaolefin. The present invention also relates to the use of lubricant compositions as described above for the lubrication of internal combustion engines, preferentially engines for motor vehicles.

The present invention also relates to a method for the preparation of lubricant compositions as described above comprising the steps of:
(a) measurement of the apparent density of a carbon nanotube powder according to the standard ISO60-ASTM D1895,
(b) dispersion of the powder in one or more base oils of mineral, synthetic or natural origin, and optionally any type of additive suitable for the use of the lubricant composition, in such a way that:
   the percentage by mass of carbon nanotubes with respect to the base oils is comprised between 0.2 and 3%, preferentially between 0.3 and 2%, preferentially between 0.4 and 1.5%,
   the ratio between the percentage by mass of carbon nanotubes and the apparent density of the carbon nanotube powder is greater than 10⁻², preferentially greater than 1.5.10⁻².

According to an embodiment, step (a) is preceded by a step of purification and/or grinding of the carbon nanotube powder. According to another embodiment, the method according to the invention does not comprise a step of purification of the carbon nanotube powder. According to another embodiment, the method according to the invention does not comprise a step of grinding of the carbon nanotube powder. According to another embodiment, the method according to the invention does not comprise a step of grinding or purification of the carbon nanotube powder.

### DETAILED DESCRIPTION

Carbon Nanotubes:

Carbon nanotubes (CNTs) are an allotropic form of carbon belonging to the family of fullerenes. Fullerenes are similar to graphite, composed of sheets of linked hexagonal rings (graphene sheets), but they contain pentagonal and sometimes heptagonal rings, which prevent the structure from being flat. Fullerenes can have various shapes, in particular spherical or tubular. Carbon nanotubes are therefore hollow tubes with very small dimensions, having one or more walls. They can have only one wall (single wall or SWNT) or several walls (multiwall or MWNT). Multiwall nanotubes can be composed of several concentric cylinders, or of a single sheet of graphene rolled up on itself like a parchment.

Depending on the orientation of the axis of the tubes with respect to the network of carbon hexagons, the nanotubes can have 3 different configurations: armchair, zigzag or chiral. The diameter of the CNTs is generally of the order of a few nanometres and their length of the order of a few micrometres. The diameter of the carbon nanotubes can for example vary approximately between 0.2 and 100 nm, or between 0.5 and 50 nm, whereas their length is of the order of a few micrometres or a few tens of micrometres, for example between 20 and 200 micrometres, or between 50 and 100 micrometres. The ratio between the length and the diameter of the nanotubes is called the “aspect ratio”, and can vary for example between 10 and 1,000,000, or between 200 and 10,000, or between 5,000 and 1,000.

The CNTs contain carbon as majority element, but can also contain other elements such as Si, Ti, V, Cr, Mn, Fe, Co, Ni, Cu, Mo, Zr, Sn, W etc. These elements can for example originate from catalysts used for their synthesis. The percentage by mass of carbon in the CNTs can be comprised between 60 and 99%, or between 80 and 98%, or between 90 and 95%, or between 92 and 94%.

The lubricants according to the present invention are not limited to such type(s) of carbon nanotubes. The carbon nanotubes of the lubricants according to the present invention can be produced by contacting a source of gaseous carbon with a metallic catalyst containing Co, Ni, Fe, Al, at temperatures of the order of 650° C. and above, for example according to the processes described in the application EP 1 736 440 and the patent EP 1 797 950. They can have been subjected to purification post treatments aimed at eliminating in particular certain elements originating from the catalysts used in their synthesis, such as Al, Fe, Co etc. In this case, their carbon content is generally greater than 95% by mass, or also greater than 98% or also greater than 99% by mass. They can also have been subjected to subsequent grinding operations.

Apparent Density:

On the macroscopic scale, the carbon nanotubes are in the form of powder. The density of the nanotubes taken individually, which is around 1700 g/l, is distinguished from that of the powder, which takes into account the arrangement of the nanotubes in the form of aggregates, trapping of the order of 80% by volume of air, and which is generally between 30 and 200 g/l. This apparent density of the powder, which is tamped down under well-defined conditions, is measured according to the standard ASTM D1895, and is expressed in grams per litre.

The production processes, but also certain post treatments undergone by the carbon nanotube powders, are capable of influencing the apparent density values. This is the case for example with processes of grinding the powders, which have the effect of reducing the size of the nanotubes and/or of compacting the aggregates, and therefore of leading to more compact arrangements and to powders with higher apparent density. Moreover, for a same grinding method, the greater the grinding time, the higher the apparent density.

The processes for the purification of the nanotubes, aimed for example at eliminating traces of catalyst, also lead to modification of the apparent density of the carbon nanotube powders. In fact, these processes are essentially processes by liquid route requiring steps of filtration and drying of the nanotube powders, which has the effect of compressing the nanotubes and increasing the compact character of their arrangements. Thus, the purification processes have the effect of increasing the apparent density of the carbon nanotube powders.

Preferentially, the apparent density of the carbon nanotubes of the lubricants according to the invention is generally comprised between 25 and 200 g/l. Powders having a low apparent density, preferentially between 30 or 40 g/l and 50 or 60 g/l are preferred, as, in these powders, the quantity of CNTs necessary to obtain an effect on the variations in viscosity of the lubricant as a function of temperature is then smaller than for CNT powders with a higher apparent density. The fact of having to include a significant quantity of CNT powder is detrimental on the one hand economically and on the other hand technically, as it can lead to the formation of gels, and therefore to problems regarding homogeneity and finally to problems regarding the performance of the lubricant. For this reason, there is a tendency to favour CNT powders obtained by processes leading straightaway to a high carbon content by mass (for example the processes described in the application EP 1 736 440 and the patent EP 1 797 950), not requiring a purification step or partial purification. Also for this reason, there is a tendency to favour carbon nanotube powders which have not been subjected to grinding, or moderate grinding.

Concentration by Mass of Carbon Nanotubes in the Lubricants:

In the lubricants according to the invention, the carbon nanotubes are dispersed in one or more base oils, and the percentage by mass of carbon nanotube powder with respect to the total weight of base oil of the lubricant is comprised between 0.15 and 3.5%, preferentially between 0.2 and 3%, preferentially between 0.5 and 2%. When this percentage by mass is too low, it can become more and more difficult to disperse the CNTs in the base oil(s), which affects their tribological or thickening performance in the lubricant. When this percentage by mass is too high, the formation of gels can be seen, which is also detrimental to the homogeneity of the dispersions and also to the tribological or thickening performance in the lubricant.

Base Oils (a):

The lubricant compositions according to the present invention comprise one or more base oils, generally representing at least 60% by weight of the lubricant compositions, generally at least 65% by weight, and possibly ranging up to 90% and more. The base oil(s) used in the compositions according to the present invention can be oils of mineral or synthetic origin of groups I to V according to the classes defined in the API classification (or their equivalents according to the ATIEL classification) as summarized below, alone or in a mixture.

| | Saturates content | Sulphur content | Viscosity index |
|---|---|---|---|
| Group I mineral oils | <90% | >0.03% | 80 ≦ VI < 120 |
| Group II | ≧90% | ≦0.03% | 80 ≦ VI < 120 |
| hydrocracked oils | | | |
| Group III | ≧90% | ≦0.03% | ≧120 |
| hydrocracked or | | | |
| hydro-isomerized | | | |
| oils | | | |

| | |
|---|---|
| Group IV | PAO Polyalphaolefins |
| Group V | Esters and other bases not included in bases |
| | of groups I to IV |

These oils can be oils of vegetable, animal, or mineral origin. The mineral base oils of lubricants according to the invention include all types of bases obtained by atmospheric and vacuum distillation of crude oil, followed by refining operations such as solvent extraction, deasphalting, solvent dewaxing, hydrotreatment, hydrocracking and hydroisomerization, hydrofinishing.

The base oils of the compositions according to the present invention can also be synthetic oils, such as certain esters of carboxylic acids and alcohols, or polyalphaolefins. The polyalphaolefins used as base oils are for example obtained from monomers having 4 to 32 carbon atoms (for example octene, decene), and have a viscosity at 100° C. comprised between 1.5 and 15 cSt. Their weight-average molecular mass is typically comprised between 250 and 3000.

Mixtures of synthetic and mineral oils can also be used. Preferentially, the lubricant compositions according to the invention are formulated with synthetic bases, preferentially polyalphaolefin (PAO). Preferably, the compositions according to the present invention have a kinematic viscosity at 100° C. comprised between 5.6 and 16.3 cSt measured by the standard ASTM D445, (SAE grade 20, 30 and 40). Preferentially, the lubricant compositions according to the invention are engine oils for gasoline or diesel vehicles.

Other Additives:

The compositions according to the invention contain carbon nanotubes, having known tribological properties, as friction and anti-wear modifiers. They can however, in the lubricant compositions according to the invention, be used in combination with other friction and anti-wear modifier compounds known to a person skilled in the art, as described below.

Anti-wear additives generally represent between 1 and 2% by weight of the lubricant compositions. They protect the friction surfaces by forming a protective film adsorbed on these surfaces. The most commonly used is zinc dithiophosphate or ZnDTP. Also found in this category are various phosphorus-, sulphur-, nitrogen-, chlorine- and boron-containing compounds.

The friction modifier additives limit friction in a mixed or limited lubrication regime. These are for example fatty alcohols, fatty acids, esters, for example fatty esters, organomolybdenum compounds etc. They are generally present at levels comprised between 0.1 and 2% by mass in the lubricant compositions. The carbon nanotubes of the lubricant compositions according to the invention are also used under conditions which allow them to have a viscosity-stabilizing effect as a function of temperature. They can however, in the lubricant compositions according to the invention, be used in combination with standard thickeners and VI improver polymers.

VI improver polymers are compounds making it possible to minimize variations in the viscosity deviation with temperature, i.e. making it possible to maintain a film of oil sufficient to protect the parts subject to friction at high temperature, and preventing too great an increase in viscosity when cold. The known viscosity index improvers are typically polyalkylmethacrylates (PMAs), polyacrylates, polyolefins, copolymers of olefins (dienes) with vinyl aromatics (styrene). They typically represent 1 to 15% by weight of the lubricant compositions.

Thickeners have the role of increasing the viscosity, of the composition, both when hot and when cold. These additives are most often polymers with low molecular weight, of the order of 2,000 to 50,000 daltons (Mn). They typically represent 1 to 15% by weight of the lubricant compositions. They are for example chosen from PIBs (of the order of 2000 daltons), polyacrylates or polymethacrylates (of the order of 30,000 daltons), olefin copolymers, copolymers of olefin and alphaolefins, EPDM, polybutenes, polyalphaolefins with high molecular weight (viscosity 100° C.>150), styrene-olefin copolymers, hydrogenated or not etc.

The lubricant compositions according to the invention can also contain all types of additives suitable for their use. A preferred use of the lubricant compositions according to the invention is their use in the form of a lubricant for an internal combustion engine, preferentially for motor vehicle engines. These additives can be added individually, or in the form of packages of additives, guaranteeing a certain level of performance to the lubricant compositions, as required, for example for an ACEA (European Automobile Manufacturers' Association) or JASO (Japan Automobile Standards Organization) diesel lubricant. By way of example and non-limitatively, these are:

Dispersants generally representing between 5 and 8% by weight of the lubricant compositions. The dispersants such as for example succinimides, PIB (polyisobutene) succinimides, Mannich bases ensure that the insoluble solid contaminants constituted by the secondary oxidation products formed when the engine oil is in service are maintained in suspension and removed.

Antioxidants generally representing between 0.5 and 2% by weight of the lubricant compositions. The antioxidants slow down the degradation of the oils in service, a degradation which can result in the formation of deposits, the presence of sludge, or an increase in the viscosity of the oil. They act as radical inhibitors or hydroperoxide destroyers. Among the antioxidants commonly used are found the phenolic type antioxidants and sterically hindered amines. Another class of antioxidants is that of the oil-soluble copper compounds, for example copper thio- or dithiophosphates, salts of copper and carboxylic acids, copper dithiocarbamates, sulphonates, phenates, acetylacetonates. Copper I and II salts of succinic acid or anhydride are used.

Detergents generally representing between 2 and 4% by weight of the lubricant compositions. The detergents are typically alkali or alkaline-earth metal salts of carboxylic acids, sulphonates, salicylates, naphthenates, as well as phenate salts. They typically have a BN according to ASTM D2896 greater than 40 or 80 mg KOH/gram of detergent, and are most often overbased, with BN values typically of the order of 150 and more, or even 250 or 400 or more (expressed in mg of KOH per gram of detergent). And also antifoaming agents, pour point depressants, corrosion inhibitors etc.

### EXAMPLES

Several dispersions of CNTs in a synthetic oil base of polyalphaolefin (PAO) type were produced, and their variation in dynamic viscosity as a function of temperature was measured, and compared with two references
Ref 1: the same PAO alone.
Ref 2: a formula of complete engine lubricant of grade 5W30, comprising as base oil the same PAO, but no CNTs. This formula is produced with a package of additives for engine oils (mixed diesel or gasoline), with an ACEA C2 performance level, comprising antioxidants, detergents, dispersants, a viscosity index improver polymer, a pour point depressant. It has a kinematic viscosity at 100° C., KV 100, of 10.63 cSt.

The base oil used is a PAO with a kinematic viscosity at 100° C., KV100=5.95 cSt. In all cases, the CNTs were MWNTs comprising approximately 90% carbon by mass, measured by Thermo Gravimetric Analysis, and containing traces of Fe, Co, Al₂O₃, and not having been subjected to a purification operation. The CNTs were used at various concentrations, between 0.1 and 2% (% by mass with respect to the total weight of base oil).

Before their dispersion in the oil certain samples were subjected to a grinding step of variable duration. The grinding is carried out in a Faure grinder. The grinding units are constituted by 1.4-I stainless steel jars with a water-tight cap that rest on two rubberized rollers. One of these rollers is driven by an electric motor and turns the jar. The other roller turns freely. The rollers are mounted on sealed roller bearings with an adjustable gap for the use of jars of 1 to 15 litres. ⅓ of the volume of the jars is filled with stainless steel balls 12 mm in diameter. The remainder of the volume is filled with nanotubes (approximately 60 g). Then the jar is placed on a roller bench at a speed and for a determined duration (0 hours, 8 hours, 16 hours, 72 hours). The entire operation is carried out in a closed system under air.

The apparent density of the CNT powder which has not been ground, and after different grinding times, was measured according to the standard ISO60-ASTM D1895, in gram/litre, on the CNT powders before their dispersion in the PAO. The dispersions of the CNTs is carried out using a 3 Roll-Mill from EXAKT, model 80E/81 and/or E120.

The nanotubes are firstly weighed in order to obtain the desired percentage by mass in the starting oil then are added to the oil and mixed rapidly in order to produce the incorporation/wetting. Then, the mixture is passed through the 3 Roll-Mill with gaps of 15 and 5 pm and at a speed of 300 rpm for the E80 and 460 rpm for the E120. Five passes are carried out in total in order to obtain the dispersions.

The dispersions tested here do not contain dispersant/stabilizer. If such dispersant/stabilizer is added, ideally it must be incorporated in the oil first, then the CNTs are added afterwards. The change in the dynamic viscosity of the references and of the CNT dispersions thus obtained were measured with an Anton Paar MCR 301 viscometer in a coaxial cylinder configuration, 27 mm in diameter. The dynamic viscosity measurements (Pa/s) were carried out under a shearing of 1000 s-1 over a range of temperatures from 30° C. to 150° C., the gradient being 2° C./min.

Table 1 shows the characteristics of the dispersions in terms of:
Concentration by mass of CNTs
Apparent density of the powders used according to ISO-ASTM D1895 (and grinding times, under the conditions described above, that make it possible to obtain said apparent density)
   Table 1 also shows the dynamic viscosity values at 40° C., 100° C. and the ratio of these viscosities to each other, for the dispersions and for the two references.

On comparing the two references Ref 1 and Ref 2, it is noted that the presence of additives (other than thickeners and VII) does not influence the change in viscosity. The dispersions D1, D2, D3, D6, D10 are according to the invention, and have a relative variation in viscosity between 40 and 100° C. less than the references. It should be noted that the higher the apparent density, the greater the quantity of CNTs to be incorporated into the oil in order to obtain a reduction in the relative variation of viscosity between 40 and 100° C.

TABLE 1

| | Ref. 1 | Ref. 2 | | D1 | D2 | D3 | D4 | D5 | D6 |
|---|---|---|---|---|---|---|---|---|---|
| | PAO alone | Engine | d g/l | 45 | 45 | 45 | 45 | 60 | 60 |
| | | formula | | | | | | | |
| | | | grinding h | 0 | 0 | 0 | 0 | 8 | 8 |
| mass % CNTs | 0 | 0 | mass % CNTs | 2 | 1 | 0.5 | 0.01 | 0.1 | 1 |
| η 40° C. | 0.0333 | 0.0333 | | 0.835 | 0.319 | 0.15 | 0.038 | 0.0453 | 0.227 |
| η 100° C. | 0.0094 | 0.00938 | | 0.329 | 0.143 | 0.0646 | 0.00787 | 0.0112 | 0.0689 |
| η 40° C./η 100° C. | 3.55 | 3.55 | | 2.54 | 2.23 | 2.32 | 4.83 | 4.04 | 3.29 |
| mass % CNTs/d | 0 | 0 | | 4.44E−02 | 2.22E−02 | 1.11E−02 | 2.22E−04 | 1.67E−03 | 1.67E−02 |

| | Ref. 1 | Ref. 2 | | D7 | D8 | D9 | D10 | D11 |
|---|---|---|---|---|---|---|---|---|
| | PAO alone | Engine | d g/l | 120 | 120 | 120 | 120 | 135 |
| | | formula | | | | | | |
| | | | grinding h | 16 | 16 | 16 | 16 | 72 |
| mass % CNTs | 0 | 0 | mass % CNTs | 0.1 | 0.5 | 1 | 2 | 1 |
| η 40° C. | 0.0333 | 0.0333 | | 0.0459 | 0.0582 | 0.0751 | 0.185 | 0.0429 |
| η 100° C. | 0.0094 | 0.00938 | | 0.0104 | 0.013 | 0.0181 | 0.057 | 0.00979 |
| η 40° C./η 100° C. | 3.55 | 3.55 | | 4.41 | 4.48 | 4.15 | 3.25 | 4.38 |
| mass % CNTs/d | 0 | 0 | | 8.33E−04 | 4.17E−03 | 8.33E−03 | 1.67E−02 | 7.41E−03 |

1. A lubricant composition comprising:
(a) at least one synthetic base oil;
(b) carbon nanotubes;
the composition having a percentage by mass of carbon nanotubes (b) with respect to the total quantity of base oils (a) of the composition comprised between 0.15 and 3.50%; and
the ratio between the percentage by mass of carbon nanotubes and the apparent density of the carbon nanotube powder, expressed in g/l and measured according to the standard ISO60-ASTM D1895, being greater than 10⁻².

2. The lubricant composition according to claim 1 in which the ratio between the percentage by mass of carbon nanotubes (b) with respect to the total quantity of base oils (a) of the composition and the apparent density of the carbon nanotube powder, measured according to the standard ISO60-ASTM D1895, is greater than 1.5.10⁻².

3. The lubricant composition according to claim 1 in which the percentage by mass of carbon nanotubes (b) with respect to the total quantity of base oils (a) of the composition is comprised between 0.2 and 3%.

4. The lubricant composition according to claim 1 in which the apparent density of the carbon nanotube powder, measured according to the standard ISO60-ASTM D1895, is comprised between 25 and 200 g/l.

5. The lubricant composition according to claim 1 in which the at least one synthetic base oil (a) is a polyalphaolefin.

6. A method of using a lubricant composition, the method comprising lubricating an internal combustion engine by supplying thereto a lubricant composition comprising:
(a) at least one synthetic base oil;
(b) carbon nanotubes;
the composition having a percentage by mass of carbon nanotubes (b) with respect to the total quantity of base oils (a) of the composition comprised between 0.15 and 3.50%; and
the ratio between the percentage by mass of carbon nanotubes and the apparent density of the carbon nanotube powder, expressed in g/l and measured according to the standard ISO60-ASTM D1895, being greater than 10⁻²;
(c) at least one synthetic base oil;
(d) carbon nanotubes;
the composition having a percentage by mass of carbon nanotubes (b) with respect to the total quantity of base oils (a) of the composition comprised between 0.15 and 3.50%,
the ratio between the percentage by mass of carbon nanotubes and the apparent density of the carbon nanotube powder, expressed in WI and measured according to the standard ISO60-ASTM D1895, being greater than 10⁻².

7. A method for the preparation of a lubricant composition according to claim 1 comprising:
(a) measurement of the apparent density of a carbon nanotube powder according to the standard ISO60-ASTM D1895;
(b) dispersion of the powder in one or more synthetic base oils in such a way that:
the percentage by mass of carbon nanotubes with respect to the base oils is comprised between 0.2 and 3%; and
the ratio between the percentage by mass of carbon nanotubes and the apparent density of the carbon nanotube powder is greater than 10⁻².

8. The method according to claim 7 where step (a) is preceded by a step of purification and/or grinding of the carbon nanotube powder.

9. The method according to claim 7 not comprising a step of purification of the carbon nanotube powder.

10. The method according to claim 7 not comprising a step of grinding of the carbon nanotube powder.

11. The method according to claim 7 not comprising a step of grinding or purification of the carbon nanotube powder.

12. The method according to claim 6 wherien the internal combustion engine is a motor vehicle engine.

13. The method according to claim 7, wherein the step (b) comprising the dispersions of the powder in one or more synthetic base oil and any type of additive suitable for the use of the lubricant composition.

14. The lubricant composition according to claim 1, further comprising at least one additive.

15. The lubricant according to claim 1 wherein said at least one synthetic base oil (a) is a polyalphaolefin and in which the apparent density of the carbon nanotube powder, measured according to the standard ISO60-ASTM D1895, is comprised between 25 and 200 g/l.

16. The lubricant according to claim 4, in which the apparent density of the carbon nanotube powder, measured according to the standard ISO60-ASTM D1895, is comprised between 40 and 60 g/l.
